(19) United States
(12) Patent Application Publication
(10) Pub. No.: US 2025/0248527 A1
(43) Pub. Date: Aug. 7, 2025

(54) FOLDABLE CONNECTING STRUCTURE FOR BED FRAME

(71) Applicant: Zinus Inc., Gyeonggi-do (KR)

(72) Inventor: Geunsik Bae, Seongnam-si (KR)

(21) Appl. No.: 19/005,188

(22) Filed: Dec. 30, 2024

(30) Foreign Application Priority Data
Feb. 4, 2024 (CN) 202420273901.7

(51) Int. Cl. A47C 19/12; F16C 11/10

(52) U.S. Cl. CPC A47C 19/122; F16C 11/10

(57) ABSTRACT

The present disclosure provides a folding connection mechanism and a bed frame, wherein the folding connection mechanism comprises a hinge, a lock buckle and a lock pin. The folding connection mechanism can improve the stability of the connection.

### CROSS-REFERENCE

This application claims the benefit of China Application No. 202420273901.7, filed Feb. 4, 2024, which is incorporated herein by reference in its entirety.

### BACKGROUND

Traditional bed frames present challenges in packaging volume and transportation. Despite improvements through folding designs, these still consume considerable space and some lack stability. Therefore, there is a pressing need for an improved folding connecting mechanism for a bed frame that reduces packaging volume, ensures easy operation, and improves user safety.

### SUMMARY

It may be beneficial to have a bed frame that is easy to assemble and disassemble, is compact for transportation, and provides a high level of stability and safety once assembled. An improved design that allows for a folding bed frame can reduce the packaging volume, facilitate the ease of operation, and improve user safety. To this end, the present disclosure provides a folding connection mechanism for bed frames. The folding connection mechanism comprises a hinge made up of two parts that can rotate independently. A lock buckle, situated on one part of the hinge, is equipped with a lock groove. A corresponding lock pin on the second part of the hinge is designed to fit into the lock groove. This configuration may provide a secure and stable connection while allowing for easy folding and unfolding of the bed frame.

In certain aspects, the present disclosure provides a folding connection mechanism, comprising: a hinge, wherein the hinge comprises a first connecting member and a second connecting member, wherein the first connecting member and the second connecting member are configured to be rotatably connected to each other; a lock buckle, wherein the lock buckle is configured to be rotatably positioned on the first connecting member, and wherein the lock buckle is equipped with a lock groove; a lock pin, wherein the lock pin is positioned on the second connecting member, and wherein the lock pin is configured to be inserted into the lock groove.

In some embodiments, the first connecting member is provided with a bolt, and the lock buckle is configured to be rotatably sleeved on the bolt. In some embodiments, the lock buckle is a flat plate whose width gradually increases from a connecting end with the first connecting member to a free end opposite to the connecting end. In some embodiments, the lock groove is arranged on the free end of the lock buckle. In some embodiments, the lock groove faces downward when the lock pin is engaged with the lock groove. In some embodiments, both ends of the lock buckle are arc-shaped.

In some embodiments, the lock pin comprises a connecting portion and a limiting portion, wherein the connecting portion is configured to be inserted into the lock groove, and wherein size of the limiting portion is larger than size of the lock groove to limit an axial falling off of the lock buckle. In some embodiments, the connecting portion is of a cylindrical shape and the limiting portion is disc-shaped. In some embodiments, the first connecting member and the second connecting member are configured to be connected to each other as a tube having a C-shaped cross-section. In some embodiments, the first connecting member and the second connecting member are separately provided with a protruding hinge portion comprising a hinge hole, wherein a hinge shaft is configured to pass through the hinge hole, thus enabling the first connecting member and the second connecting member to be rotatably connected.

In certain aspects, the present disclosure also provides a bed frame comprising a plurality of bed frame units and at least one folding connection mechanism. The at least one folding connection mechanism comprises the folding connection mechanism disclosed herein. In some embodiments, the at least one folding connection mechanism is configured to position between at least two respective adjacent bed frame units of the plurality of bed frame units.

In some embodiments, the plurality of bed frame units comprises a plurality of side rods, wherein the first connecting member and the second connecting member are each separately welded to the plurality of side rods. In some embodiments, the bolt is configured to pass through the side rod.

In some embodiments, the connecting portion of the lock pin extends from one side of the second connecting member through a side rod of the plurality of side rods until the connecting portion connects to the other side of the second connecting member. In some embodiments, the plurality of bed frame unit is configured to be arranged in at least four sections, wherein the four sections of the plurality of bed frame units are arranged in sequence, and at least two adjacent bed frame units of the plurality of bed frame units are connected by the at least one folding connection mechanism.

In some embodiments, the bed frame comprises four bed frame units and the at least one folding connection mechanism disclosed herein, wherein the at least one folding connection mechanism is configured to position between at least two respective adjacent bed frame units of the four bed frame units. In some embodiments, the plurality of bed frame units comprises a plurality of side rods, wherein the first connecting member and the second connecting member are each separately welded to the plurality of side rods. In some embodiments, the bolt is configured to pass through the side rod.

In some embodiments, the connecting portion of the lock pin extends from one side of the second connecting member through a side rod of the plurality of side rods until the connecting portion connects to the other side of the second connecting member. In some embodiments, when the lock groove of the lock buckle is engaged with the connecting portion of the lock pin, the lock groove of the lock buckle is configured to be arranged on one side close to a transverse line of the plurality of bed frame units, while a hinged side of the lock buckle is away from the transverse line of the plurality of bed frame units.

It shall be understood that different aspects of the invention can be appreciated individually, collectively, or in combination with each other. Various aspects of the invention described herein may be applied to any of the particular applications set forth below or for any other types of furniture. Any description herein of structures for bed frames may apply to and be used for any furniture. Other objects and features of the present invention will become apparent by a review of the specification, claims, and appended figures.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a schematic diagram of a folding connection mechanism, in accordance with one or more embodiments of the present disclosure.

FIG. 2 shows a locking status of the folding connection mechanism, in accordance with one or more embodiments of the present disclosure.

FIG. 3 shows a locking status of the folding connection mechanism from another angle, in accordance with one or more embodiments of the present disclosure.

FIG. 4 shows a unlocking status of the folding connection mechanism, in accordance with one or more embodiments of the present disclosure.

FIG. 5 shows a unlocking status of the folding connection mechanism from another angle, in accordance with one or more embodiments of the present disclosure.

FIG. 6 shows a partial enlarged view of the bed frame, in accordance with one or more embodiments of the present disclosure.

FIG. 7 shows a schematic diagram of the bed frame, in accordance with one or more embodiments of the present disclosure.

FIG. 8 shows a bed frame that can be divided into four units, in accordance with one or more embodiments of the present disclosure.

FIG. 9 shows two bed frames stacked together, each folded to approximately one-quarter of its original length, in accordance with one or more embodiments of the present disclosure.

### DETAILED DESCRIPTION

The present disclosure relates generally to the field of furniture design, and more particularly to the development of bed frame structures. One of the primary challenges in this field is the efficient packaging and transportation of these large-scale items, specifically bed frames. Traditional bed frames, owing to their large and rigid structure, pose difficulties in terms of packaging volume, transportation, and handling. To address this challenge, the folding bed frame was introduced. A conventional folding bed frame usually folds symmetrically along its middle crossbar, forming a two-fold bed frame. This design reduces the packaging volume and eases transportation and handling. However, even when collapsed, this two-fold bed frame still occupies a considerable volume, thus leaving room for further optimization.

To reduce the packaging volume and complexity of transportation, multi-link folding bed frames have been introduced. Although they have achieved some success in reducing volume, these designs are often complex to operate and lack stability, making them less than ideal for practical use. For example, a four-fold iron frame bed may include a design that splits the bed frame into four distinct frame units connected via hinges. However, this design suffers from practical issues. If uneven stress is applied to the bed frame units during usage, the frame unit bearing less stress tends to lift, causing the hinges to fold unintentionally due to gravity. This not only affects the stability of the bed frame but also creates a potential safety risk for the user.

Therefore, there is a clear need for an improved folding connecting mechanism for a bed frame that can efficiently reduce packaging volume while maintaining ease of operation and user safety. The present disclosure addresses this need by providing a four-fold bed frame design that combines efficient folding, easy operation, and stability.

Systems and methods provided herein advantageously provide a foldable bed frame design that provides improved folding connection mechanisms. The foldable bed frame design may be a multi-foldable bed frame design that may include a plurality of folding connection mechanisms. Such a connection mechanism may include a hinge or other rotating feature. The connection mechanism may include a locking feature, that may increase the foldable bed frame when in an unfolded state. This may advantageously permit the usage of a foldable bed frame that would take up reduced space during shipping or storage, while also providing sufficient stability to reduce safety risks.

### Folding Connection Mechanism

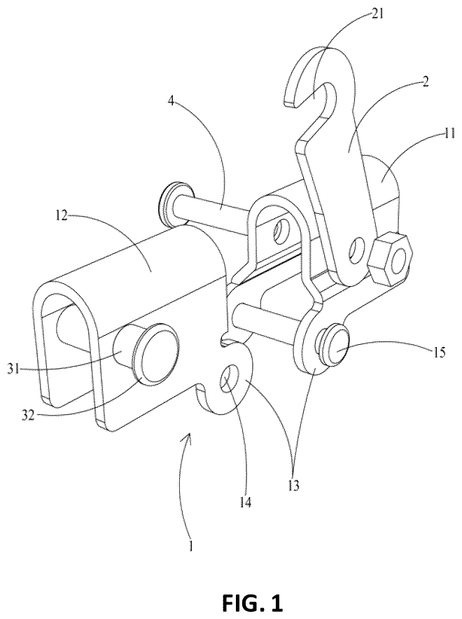

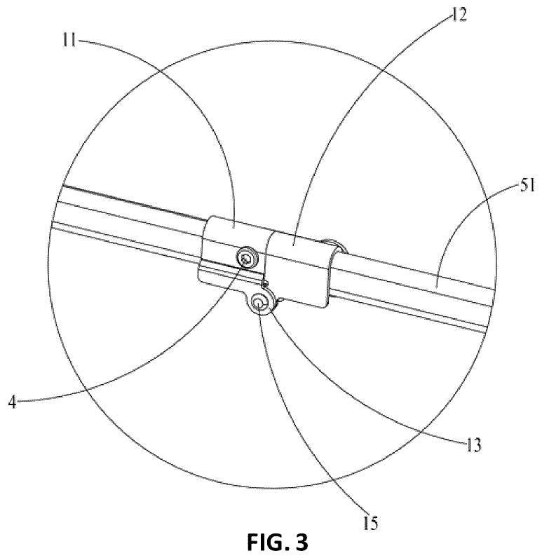

In certain aspects, the present disclosure provides a folding connection mechanism for a bed frame as shown in FIG. 1-FIG. 3. Any description herein of a bed frame may also apply to any other furniture or structural frame for furnishings, including but not limited to beds, cots, futons, sofas, chairs, tables, canopies, tents, or other structures therein. The folding connection mechanism may be provided at a foldable portion of the structural frame.

In some embodiments, the folding connection mechanism may comprise a rotating or foldable mechanism (such as a hinge (1), and a locking mechanism, (such as a lock buckle (2), and a lock pin (3)). The terms “lock buckle” and “clasp” are often used interchangeably herein. The terms “lock pin” and “pin” are often used interchangeably herein.

The rotating or foldable mechanism may allow one or more portions of a bed frame to rotate relative to one another about an axis perpendicular to the length of the one or more portions. The portions of the bed frame may be substantially parallel to one another when the bed frame is in an unfolded state. The portions of the bed frame may rotate between a (i) folded state where the portions are substantially parallel and/or next to each other and (ii) an unfolded state where the portions are substantially in line with one another. The rotating or foldable mechanism may comprise a hinge (1).

The hinge (1) can comprise a first connecting member (11) and a second connecting member (12). In some embodiments, the first and second connecting members can each be structured as a tube with interior space. The first and second connecting member may comprise an interior space that may be configured to accept a portion of the bed frame. For instance, one or more elongated portion of a bed frame may slide into the first and/or second connecting member. The first and/or second connecting member to allow for a snug fit of portion of the bed frame within. A first and second portion of the bed frame may be aligned with the respective first and second connecting members.

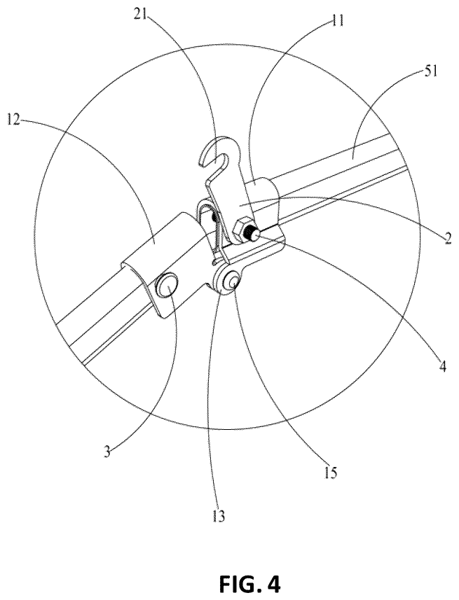

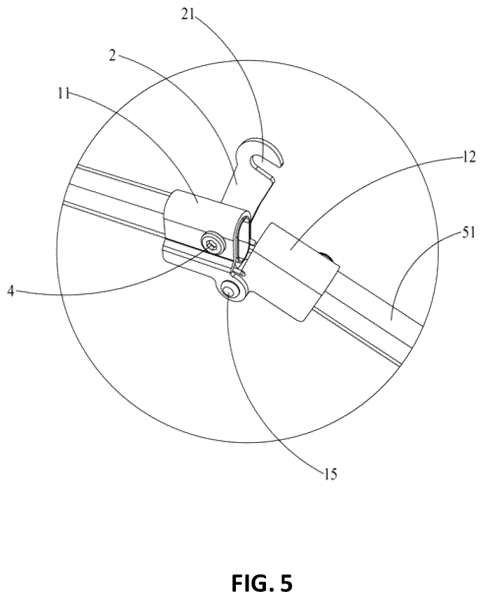

As displayed in FIG. 4 and FIG. 5, a cross section of the first and second connecting members can each be C-shaped. In some embodiments, a cross section of the first and second connecting members can each be oval-shaped. The cross-section of the first and second connecting members may comprise at least one curved surface. In some instances, the cross-section of the first and second connecting members may comprise one or more, or two or more flat sides. The cross section's corners may optionally be rounded or straight. The cross-section of the first and second connecting members may encompass at least 50%, 60%, 70%, 80%, 90%, or 100% of the circumference of a respective bed frame portion received therein. The first connecting member and the second connecting member are configured to be rotatably connected to each other.

In some embodiments, the first connecting member and the second connecting member are configured to be connected to each other as a tube. For instance, when a section of the bedframe is in an unfolded state, the first and second connecting members may be in line with one another and may optionally share a longitudinal axis. The first and second connecting members may be aligned in an unfolded state to form a tubular space therein. There may be a gap between the first and second connecting members when they are aligned. Alternatively, the first and second connecting members may contact one another when aligned. In some embodiments, the first connecting member and the second connecting member are configured to be connected to each other to form as a tube having a C-shaped cross section. In some embodiments, the first connecting member and the second connecting member are configured to be connected to each other as a tube having an oval-shaped cross section. The collective interior space within the first and second connecting members may form a cylindrical shape, prismatic shape, or similarly elongated shape.

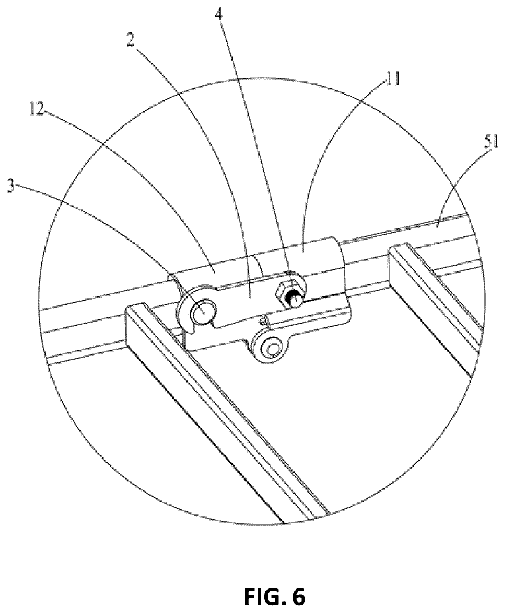

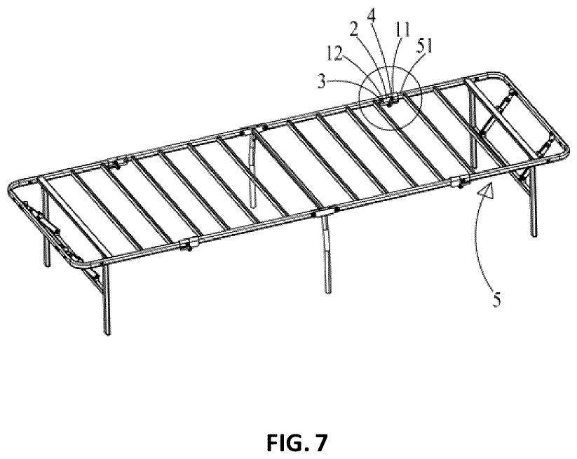

As shown in FIG. 6 and FIG. 7, the first connecting member can be used to connect a bed frame unit comprising a side rod (51), and the second connecting member can be used to connect another bed frame unit comprising a side rod. The side rods may be portions of the bed frame unit that may couple to the respective first and second connecting members. The side rods may rotate with the respective first and second connecting members between a folded state where they are adjacent to one another and substantially parallel, and an unfolded state where they are in line with one another.

The hinge comprising the first and second connecting members may also comprise a hinge shaft (15). The terms “hinge shaft” and “axis” are often used interchangeably herein. Any description herein of a hinge shaft may apply to any longitudinal structure which may include, but is not limited to, a bolt, screw, pin, cylinder, or bar. The first and second connecting members may each comprise a protruding hinge portion (13). The protruding hinge portions may extend from the respective connecting members and may overlap with one another. The assembled hinge may allow a first protruding hinge section to overlie or be exterior to a second protruding hinge portion. Each protruding hinge portion may comprise a hole (14) or opening. The holes of the respective protruding hinge portions may align when the hinge is assembled. The hinge shaft may pass through the holes. In some embodiments, each hinge may comprise a pair of aligned holes that may accept the hinge shaft. The hinge shaft may form a rotation axis that is in line with (e.g., parallel to) the longitudinal axis of the hinge shaft. The hinge may allow for rotation between the first and second connecting members (and optionally the respective side rods) about the hinge rotation axis. The hinge shaft, configured to pass through the hinge holes of both the first connecting member and second connecting member, is provided to enable the rotatable connection between the first and second connecting members.

The hinge shaft and/or the rotation axis may be positioned on the protruding hinge portions such that when the first and second connecting members are in an unfolded state, they come into contact with one another. The first connecting member may have a contact end that faces the second connecting member, and the second connecting member may have a contact end that faces the first connecting member when in an unfolded state. The contact end of the first connecting member may come into contact with a contact end of the second connecting member. The contact ends may be substantially be flush against one another when in an unfolded state. The contact ends may optionally not have a gap between then when in an unfolded state. The contact between the contact ends of the first and second connecting members may be provided around at least 50%, 70%, 80%, 90%, 95%, 99%, or 100% of the circumference of the connecting members. The first and second connecting members may be a fully unfolded state when they contact one another and are substantially in line with one another. The longitudinal axes of the respective connecting rods may be substantially in line and/or parallel to one another in the unfolded state. The first and second connecting members may come into contact in an unfolded state to prevent over-rotation and/or over-extension of the bed frame units. This may permit the bed frame top surface to be substantially flat when in an unfolded state. A plane may be formed where the first and second connecting members come into contact with one another. The hinge shaft and/or hinge rotation axis may be on the plane (e.g., coplanar with where the first and second connecting members come into contact).

The hinge may comprise a locking mechanism. The locking mechanism may prevent the first and second connecting members from returning to a folded state, after they have been locked into an unfolded state. For instance, a bed frame unit may rotate between a folded and unfolded state until the locking mechanism is engaged. When the locking mechanism is engaged while the bed frame unit is in an unfolded state, the bed frame unit will remain in the unfolded state. This may reduce the risk of the bed frame collapsing or moving in an undesirable manner where in use, which may improve safety. Furthermore, such a mechanism may also increase the life of a bedframe by providing additional structural support and more reliably remaining in an unfolded state when in use. The locking mechanism may comprise a lock buckle (2) and a lock pin (3).

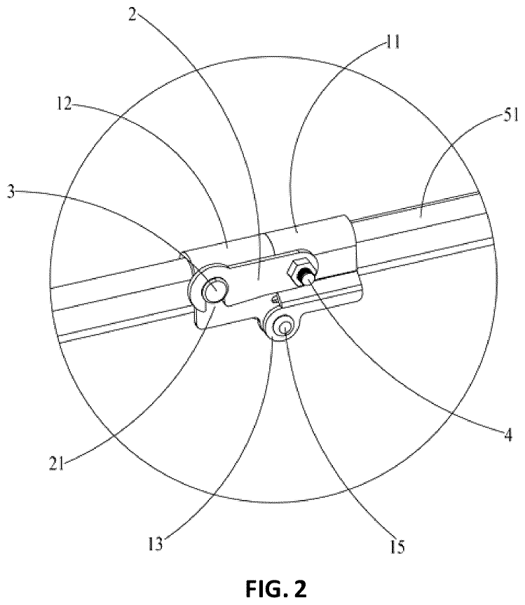

The lock buckle (2) can be designed to be rotatably positioned on the first connecting member. The lock pin may be positioned on the second connecting member. The lock buckle may comprise a lock groove (21). The lock groove may include a recessed space. In some embodiments, the lock pin may be configured to be inserted into the lock groove when the locking mechanism is engaged. Through the rotation of the lock buckle, the lock pin can be inserted into the lock groove, thus linking the lock buckle with the lock pin. This design strategy enhances the connection stability between the first and second connecting members. Moreover, the structure is simple, facilitating ease of operation. These structural features are illustrated in FIG. 1-FIG. 2.

In certain embodiments, a hinge connects the outer part of a bed frame to an adjacent inner part. The hinge may include an axis (hinge shaft). In some embodiments, a clasp (lock buckle) and a pin (lock pin) can be fixed to the hinge. In some embodiments, the two parts of the bed frame can rotate around the axis, allowing the clasp to secure to the pin. This connection enhances the stability of the bed frame when it is in the unfolded position. Without this locking mechanism, if someone sits on one end of the frame, the connection point between the two parts may rise, potentially leading to a collapse of the frame.

The lock buckle may be supported on the first connecting member by a rotatable connection. In some embodiments, a bolt (4) may be furnished on the first connecting member, and the lock buckle can be rotatably sleeved on the bolt. Any description herein of the bolt (4) may apply to any longitudinal structure which may include, but is not limited to, a shaft, screw, pin, cylinder, or bar. In some embodiments, the lock buckle can be rotatably sleeved on the bolt and restricted by a nut. The lock buckle may rotate with respect to the first connecting member about an axis longitudinally aligned with the bolt (e.g., buckle rotation axis). The lock buckle may optionally freely rotate (360 degrees) about the buckle rotation axis. Alternatively the angle of rotation of the buckle about the buckle rotation axis may be restricted to a limited range. The buckle may be restricted from moving relative to the first connecting member along the buckle rotation axis (e.g., in the direction of the buckle rotation axis). In some embodiments, the nut may hold the buckle against the first connecting member. The buckle may be frictionally held against the first connecting member to slow the rotation of the buckle.

In some embodiments, the lock buckle can be a flat plate with a connecting end and a free end. A length of the lock buckle may extend from the connecting end to the free end. A width of the lock buckle may substantially be perpendicular to the length of the lock buckle and may be coplanar with the flat surface of the lock buckle. A thickness of the lock buckle may be substantially perpendicular to the length and the width of the lock buckle. The lock buckle may have a width that gradually expands from the connecting end coupled to the first connecting member to the free end opposite to the connecting end. This structure results in a larger width at the free end that will couple with the lock pin, thus enhancing connection stability. The width at or near the free end of the lock buckle may be greater than the width at or near the connecting end. Alternatively, the widths of the lock buckle may substantially the same between the free end and connecting end or may alter in a non-gradual manner.

In some embodiments, the lock groove can be provided at the free end opposite to the connecting end of the lock buckle and the first connecting member. In such cases, the entrance of the lock groove could be designed as a square mouth for quick alignment with the lock pin. The opening of the lock groove may be rounded or may have one or more straight portions. The entrance of the opening of the lock groove may be the greatest dimension of the lock groove. Alternatively, the opening of the lock groove may be smaller than the greatest dimension of the lock groove, which may allow a pin to be ‘squeezed’ and ‘locked’ in. The lock groove may have a C-shape. The lock groove may be sized and/or shaped to correspond to the lock pin. In certain embodiments, both ends of the lock buckle might be arc-shaped or curved to minimize potential harm to individuals from sharp corners.

In some embodiments, a folding connection mechanism may have a ‘down’ side that corresponds to the side with the protruding hinge portions. The folding connection may have an opposing ‘up’ side that corresponds where the first and second connecting members rotate to come into contact and form an aligned surface. When buckled and connected with the lock pin, the lock groove can be configured to face downward, ensuring a relatively stable connection between the lock buckle and the lock pin, thereby reducing the chances of the lock buckle falling off. The lock buckle may be configured such that the connecting end is connected to the first connecting member about the buckle rotation axis, such that the entrance to the lock groove is facing toward the ‘down’ side. The lock buckle may be rotated to engage with the pin. When engaged, the lock buckle may prevent the first connecting member from rotating relative to the second connecting member. The lock buckle may prevent the foldable connection mechanism from budging from its unfolded state. These structural features are illustrated in FIG. 1-FIG. 5.

The lock pin can be situated on the second connecting member. As depicted in FIG. 1, the lock pin is composed of a connecting portion (31) and a limiting portion (32). The connecting portion is configured for insertion into the lock groove. In some embodiments, the connecting portion is of a cylindrical shape, and the limiting portion is disc-shaped. Optionally, the limiting portion may have a greater cross-sectional dimension than the connecting portion. The cross-sectional dimension may be a diameter, diagonal, length, width, radius or other dimension. In some embodiments, the size of the limiting portion can be larger than the size of the lock groove. This size differential may prevent the lock buckle from axially falling off the lock pin, thus ensuring the stability of the connection.

The folding connection mechanism disclosed herein presents a simple structure and ease of operation. This mechanism considerably enhances connection stability between the first and second connecting members. This enhancement is a result of a specific structural design wherein the lock buckle is rotatably positioned on the first connecting member, and is equipped with a lock groove, while the lock pin is situated on the second connecting member. The act of rotating the lock buckle enables the insertion of the lock pin into the lock groove, thereby establishing a connection between the lock buckle and the lock pin. This connection leads to an improvement in the stability of the overall connection.

Due to the presence of the locking mechanism, the folding connection member may be able to withstand greater loads without budging from an unfolded state. This may be particularly important in bed frames or other furniture, where great forces may be applied from user body weight. In some instances, the locking mechanism may increase the load that the connection mechanism can withstand without folding by at least 10%, 20%, 30%, 40%, 50%, 75%, 100%, or 200%. In some instances, the locking mechanism may allow the folding connection member to remain locked, even in the event of loads of at least 10 kg, 20 kg, 30 kg, 50 kg, 75 kg, 100 kg, 200 kg, 300 kg, or 500 kg.

The use of the lock buckle and pin for the locking mechanism may advantageously provide the desired stability while being a cost-effective and easily manufacturable configuration to include in the bed frame. Furthermore, the locking mechanism may be sized so that it does not protrude from the bed frame by more than 0.1 cm, 0.3 cm, 0.5 cm, 1 cm, or 2 cm, which may reduce the likelihood of snags or catching on other items. The locking mechanism may also be easily employed manually without the use of tools. This may be desirable for easy and quick set-up of the bed frame.

### Bed Frame

In certain aspects, the present disclosure provides a bed frame as shown in FIG. 6-FIG. 7. In some embodiments, the bed frame comprises a plurality of bed frame units (5), and the folding connection mechanism disclosed herein. In some embodiments, the bed frame comprises a plurality of bed frame units and at least one folding connection mechanism. The at least one folding connection mechanism is configured to position between at least two respective adjacent bed frame units of the plurality of bed frame units. The folding connection mechanism can be positioned between the bed frame units. the folding connection mechanism comprises a hinge (1), a lock buckle (2), and a lock pin (3). The hinge (1) can comprise a first connecting member (11) and a second connecting member (12). In some embodiments, the first and second connecting members can each be structured as a tube with interior space. In some embodiments, a cross section of the first and second connecting members can each be C-shaped. In some embodiments, a cross section of the first and second connecting members can each be oval-shaped. The first connecting member and the second connecting member are configured to be rotatably connected to each other. The first connecting member is configured to connect a bed frame unit, and the second connecting member is configured to connect another bed frame unit.

In some embodiments, the first connecting member and the second connecting member can be separately provided with a protruding hinge portion (13). In some embodiments, the hinge portion of the first connecting member can be provided with a hinge shaft (15) and the hinge portion of the second connecting member can be provided with a hinge hole (14). In some embodiments, the hinge portion of the second connecting member can be provided with a hinge shaft (15) and the hinge portion of the first connecting member can be provided with a hinge hole (14). In some embodiments, the hinge shaft can be configured to pass through the hinge hole, thus enabling the first connecting member and the second connecting member to be rotatably connected as shown in FIG. 1 and FIG. 2. In some embodiments, the hinge shaft is an independent component. In some embodiments, the hinge shaft is configured to pass through the hinge holes of both the first connecting member and the second connecting member to provide the rotatable connection between the first and second connecting members.

The folding connection mechanism may have any characteristics or configurations as described elsewhere herein. In some embodiments, one or more folding connection mechanisms may possess any characteristics or configurations as detailed elsewhere herein. In some embodiments, not every connection mechanism adheres to the structure described herein. For instance, as illustrated in FIG. 7, a central hinge may be used to connect two bed frame units, but need not conform to the structure described in the present disclosure. Within a bed frame folding connections may have different configurations and not all configurations need to lock. For instance, folding connection mechanisms between an outer unit and an inner unit may lock, while a folding connection mechanism between two central inner units need not lock.

In some embodiments, the bed frame unit comprises a plurality of side rods (51). The side rods of the bed frame may be connected to the first and second connecting members of the folding connecting mechanism. A first side rod may be connected to a first connecting member and a second side rod may be connected to the second connecting member. As the first and second connecting members may rotate relative to one another during folding or unfolding, the corresponding side rods may rotate as well. A elongated length of the side rods may be in line with the longitudinal axis of the respective connecting member. In some embodiments, the first connecting member and the second connecting member can be each separately welded to the plurality of side rods. The first and second connecting members may be attached to the respective side rods through any mechanism including, but not limited to, adhesives, fasteners (e.g., screws, bolts, flanges, etc.), hook and loop configurations, press-fits, melting, soldering, or any other technique.

In some embodiments, the bolt connected to the lock buckle can be designed to pass through the first connecting member. The side rod may also comprise one or more holes or openings that may allow the bolt to pass through. The bolt may pass through the side rod, further enhancing the connection strength between the first connecting member and the bed frame unit. In some embodiments, the connecting portion of the lock pin can extend from one side of the second connecting member through the side rod in the opposite direction, until it reaches and connects with the opposite side of the second connecting member. Similarly, the side rod corresponding to the second connecting member may comprise one or more holes that may allow the pin to pass through. The lock pin may pass through the side rod, further enhancing the connection strength between the second connecting member and bed frame unit. This arrangement not only bolsters the connection strength between the second connecting member and the bed frame unit, but also, when the bed frame is unfolded, augments the strength and service life of the lock pin. These structural features are illustrated in FIG. 1 and FIG. 4.

The bed frame may be a foldable bed frame, which may include a plurality of bed frame units that may fold relative to one another. For example, the bed frame may include two or more, three or more, four or more, five or more, six or more, 8 or more, or 10 or more bed frame units that may fold relative to one another. A folding connection mechanism may be provided between bed frame units. A bed frame may comprise, one, two, three, four, five, six, seven, eight, nine, ten, or more folding connection mechanisms. In some instances, two folding connection mechanisms may be provided between two bed frame units; one connection mechanism may be provided on each side of bed frame unit. For example, two bed frame units may be provided between two bed frame units of a bed frame. Within a bed frame, each connection between two bed frame units may comprise one or two folding connection mechanisms.

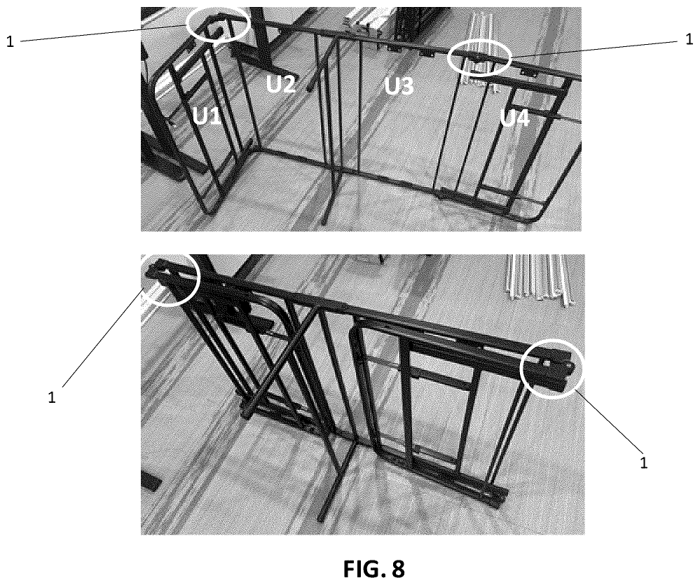

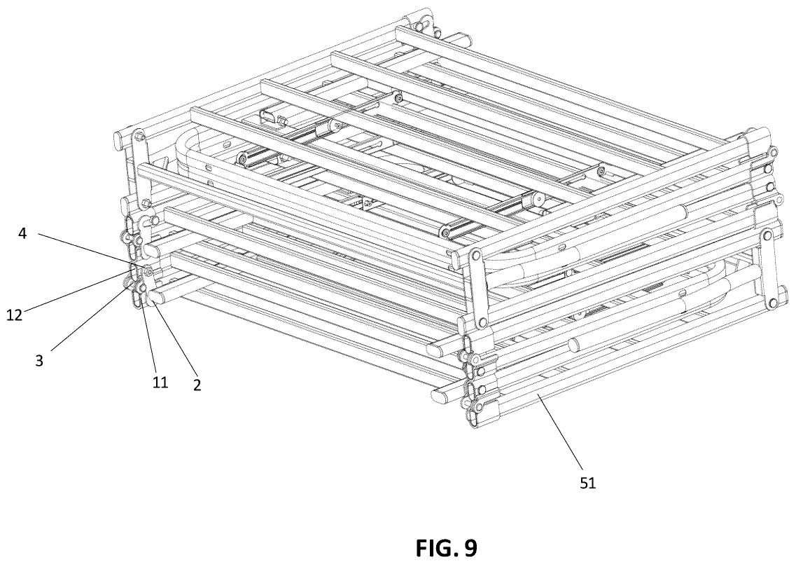

In certain embodiments, the bed frame can be divided into four units, as shown in FIG. 8. These four units of the bed frame can be sequentially arranged, with adjacent units linked by a folding connection mechanism disclosed herein. The bed frame may be divided into four parts along the length of the frame, comprising a first unit of the bed frame (U1), two middle units (U2 and U3), and a final unit (U4). The first unit of the bed frame (U1) and the final unit (U4) are symmetrically designed, as are the two middle units (U2 and U3). Each pair of adjacent units (U1 and U2, U3 and U4) within the bed frame can be interconnected by the folding connection mechanism disclosed herein. In some embodiments, the outer unit can be folded towards the inner unit, i.e. U1 can be folded towards U2, while U4 can be folded toward U3, then fold again along the center of the frame. This design allows the bed frame to be folded to approximately one-quarter of its original length, thus optimizing the bed frame's space utilization, as shown in FIG. 8-FIG. 9. FIG. 9 shows two bed frames, which folded to approximately one-quarter of its original length, stacked together. Such folding designs may reduce the footprint of the bed frame for shipping and/or storage, when not in use. The bed frame may have a first side and a second opposing side, that may each extend along each of the bed frame units. The first side and second side may have parallel longitudinal axes. The length of the first side and the second side may extend a long a length of the bed frame.

In some embodiments, one or more folding connection mechanisms may be provided between a first unit (U1) and a second unit (U2). For instance, a pair of folding connection mechanisms may be provided between the first unit and the second unit. The pair of folding connection mechanisms may be on different sides of the bed frame (e.g., first side and second side). Similarly, one or more folding connection mechanisms may be provided between a fourth unit (U4) and a third unit (U3). For instance, a pair of folding connection mechanisms may be provided between the fourth unit and the third unit. The pair of folding connection mechanisms may be on different sides of the bed frame (e.g., first side and second side). Optionally, the bed frame units at the outer ends (U1, U4) may fold down and underneath the central bed frame units (U2, U3). The downward direction may be the direction of the bed frame that has legs that may come into contact with the underlying surface. The upward direction of the bed frame may be the portion of the bed frame configured to come into contact with a mattress, pad, or box spring.

Optionally, the second and third bed frame units (U2 and U3) may be configured to be rotatable and/or foldable relative to one another. The connector between U2 and U3 may have a different configuration from the folding connection mechanism as provided herein. For instance, a bar may be provided to connect the central bed frame units. The bar may permit rotation of the central bed frame units. The bar may or may not include a locking mechanism. The connector between the central bed frame units may optionally permit rotation in either direction when the bed is folded (e.g., folding upwards or folding downwards). Alternatively, the connector between the central bed frame units may limit the direction of folding into a single direction (e.g., same direction of folding as the folding connection mechanisms, or opposite the direction of folding as the folding connection mechanism). Alternatively, a similar folding connection mechanism may be used. In some embodiments, the folding connection between the central bed frame units may also be downward.

In some embodiments, a bed frame may be folded by folding the outer bed frame units in toward the center, along the folding connection mechanisms as described. This may reduce the bed frame footprint by about a half. Then the bed frame may be further folded inwards at the central bed frame units so that the folded outer bed frame units come into contact with one another. The central bed frame units may form the outer surface of the folded bed frame. The outer bed frame units may be located on the interior portion of the folded bed frame.

In some embodiments, the plurality of bed frame unit may be configured to be arranged in at least four sections. In some embodiments, the four sections of the plurality of bed frame units may be arranged in sequence, and at least two adjacent bed frame units of the plurality of bed frame units may be connected by the at least one folding connection mechanism.

The bed frame may include one or more cross bars that may laterally span between the first side of the bed frame and the second side of the bed frame. The cross bars may be substantially perpendicular to the first side and/or the second side of the bed frame. The cross bars may provide support for the bed frame, and may be useful for holding up the mattress, pad, boxspring, or other materials provided on top of the bed frame.

The folding connection mechanisms as described may be positioned so that the lock buckle of the locking mechanism is on the interior side of the bed frame. The lock buckle may be positioned so that the lock buckle faces the cross bars of the bed frame. The folding connection mechanisms may be designed so that the lock buckles within a corresponding pair of folding connection mechanisms (e.g., the pair of folding connection mechanisms between U1 and U2, or the pair of folding connection mechanisms between U4 and U3), face one another. Having the interior-facing lock buckles may advantageously reduce the sidewards protruding portions from the bed frame when unfolded, which may result in less snags or items getting caught on the mechanism during daily use.

In other embodiments, the lock buckles may be facing the exterior side of the bed frame. For instance, the lock buckles may face away from the cross bars of the bed frame. The lock buckles for the corresponding pairs may face away from one another. In other embodiments, there may be any combination of inward and/or outward facing lock buckles.

The bed frame may have one or more sets of legs that may extend down and make contact with an underlying surface, such as the floor. The bed frame legs may be foldable. In some instances, the bed frame may comprise four or more, six or more, eight or more, or ten or more legs. In some embodiments, a pair of legs may be provided at or near the middle of the bed frame (e.g., at or near a connector between central bed frame units). A pair of legs may be provided at each end bed frame unit. For example, a pair of legs may be supported by a first bed frame unit (U1), a fourth bed frame unit (U4) and between central bed frame units (U2, U3). The folding connection mechanisms may be positioned between the legs. For example, a first pair of folding connection mechanisms may be positioned between a first outer set of legs and a central set of legs, and a second pair of folding connection mechanisms may be positioned between a second outer set of legs and the central set of legs.

In certain aspects, the folding connection mechanism is designed to link the outer unit with the adjacent inner unit of the bed frame. When folding the frame is required, it is a simple process of moving the lock buckle away from the lock pin to disengage the locking structure. In some embodiments, folding the bedframe frame may be performed by simply removing the clasp (lock buckle) from the pin to release the locking mechanism. This allows the frame to be folded easily without the need for any tools, making it very user-friendly for consumers to fold and unfold. This allows the bed frame to be folded easily without the need for any tools, offering consumers a straightforward method to fold and unfold the bed frame. The hinge of the folding connection mechanism can be welded onto the rod of the bed frame or attached in any other manner. Further, the connecting bolt of the lock buckle (clasp) and the pin can be designed to pass through both the hinge and the rod of the bed frame, thereby enhancing the connection strength between the hinge and the bed frame. The hinge may be welded to the pipe of the bed frame (the rod of the bed frame), and the connecting bolt of the clasp and pin may pass through both the hinge and the frame's pipe, which can enhance the connection strength between the hinge and the frame. When the bed frame is unfolded, the hinge and the rod of the bed frame may be aligned such that their ends meet. This alignment may increase the area of contact between the hinge and the rod of the bed frame. A larger contact surface can provide a stronger connection, enhancing the stability and durability of the bed frame when it is in use. By aligning the end of the hinge with the end of the rod of the bed frame, the contact surface may be increased when the bed frame is in an unfolded state. When in an unfolded state, contact ends of the first and second connecting members may come into contact with one another to form the contact surface. Similarly, corresponding rods of the bed frames may have contact surfaces that come into contact with one another to form at least a portion of the contact surface. This may prevent overextension or rotation of bed frame sections when in an unfolded state, even when a load may be applied.

When the lock groove of the lock buckle is engaged with the connecting part of the lock pin, the design ensures the lock groove is situated on the side nearer to the bed frame unit's transverse center line, while the hinged side of the lock buckle is distanced from this center line. This positioning ensures that the lock buckle of the folding connection mechanism does not inadvertently slip off and cause the bed frame to fold spontaneously, even when the transverse end of the bed frame unit is under greater force and the opposite end experiences a lift due to less force. Conversely, if the lock groove of the lock buckle was located farther from the transverse center line of the bed frame unit and the hinged side of the lock buckle was closer to this center line, there would exist a risk of the lock buckle dislodging. This risk stems from the top-down insertion of the lock buckle into the lock pin's connecting part. In the present disclosure, the length direction is regarded as the longitudinal direction, and the width direction is defined as the transverse direction. These structural features are illustrated in FIG. 6.

In some embodiments, the bed frame comprises a lock buckle that is rotatably situated on the first connecting member. The lock buckle is equipped with a lock groove, while a lock pin is provided on the second connecting member. Upon rotation of the lock buckle, the lock pin can be inserted into the lock groove, thus connecting/locking the lock buckle with the lock pin. This arrangement improves the connection stability between the first and second connecting members. The design is simple and easy to operate. Specifically, when the bed frame is sectioned into multiple bed frame units and these units experience uneven forces during use, the side of the bed frame unit subjected to less force may lift, leading the hinge of the bed frame unit to automatically fold due to gravity. By allowing the lock pin to insert into the lock groove and hence connect the lock buckle with the lock pin, the stability of the connection between the bed frame units can be significantly increased.

### Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

As used in the specification and claims, the singular forms “a”, “an” and “the” include plural references unless the context clearly dictates otherwise. For example, the term “a sample” includes a plurality of samples, including mixtures thereof.

The term “exemplary” as used herein means “serving as an example, instance, or illustration.” Any embodiment described herein as “exemplary” is not to be construed as preferred or advantageous over other embodiments.

The terms such as “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, and “counterclockwise”, are used throughout this disclosure to denote orientation or positional relationships based on the indications in the drawings. Note that these terms are utilized merely to facilitate the description of the invention and to simplify explanations. They do not imply that the referenced devices or elements must maintain a specific orientation, or be structured and operated in a specific manner. Consequently, these terms should not be construed as imposing limitations on the scope of the present disclosure.

The terms “first” and “second” as used herein are utilized solely for descriptive purposes and should not be construed as indicating or implying any relative importance or indirectly suggesting the quantity of technical features specified. The attributes defined as “first” or “second” can explicitly or implicitly incorporate one or more of these said features. It should also be noted that in the context of the present disclosure, the term “multiple” signifies two or more, unless otherwise clearly and specifically defined.

In the present disclosure, unless explicitly specified or limited otherwise, terms such as “installed”, “connected”, “connected”, and “fixed” are to be understood in their broadest sense. For instance, they could denote a fixed connection, a detachable connection, or a one-piece construction. They might also refer to either a mechanical or an electrical connection. These terms may encompass a direct connection or indirect connections via an intermediary medium, and could denote an internal connection between two components or an interaction relationship between them. For a person of ordinary skill in the art, the precise meanings of these terms can be comprehended based on their specific circumstances.

In the present disclosure, unless explicitly specified or limited otherwise, when the first feature is described as being “above” or “below” the second feature, it may imply either direct contact between the first and second features, or contact facilitated through another feature positioned between them. Moreover, when the first feature is described as being “above”, “over”, or “on” the second feature, this encompasses scenarios where the first feature is directly above or at an angle above the second feature, or simply indicates that the first feature is at a higher level than the second feature. Similarly, when the first feature is described as being “below”, “under”, or “beneath” the second feature, this covers situations where the first feature is directly below or at an angle below the second feature, or simply suggests that the first feature is at a lower level than the second feature.

In the present disclosure, the reference to terms such as “one embodiment”, “some embodiments”, “example”, “specific example”, or “some examples” indicates that the specific features, structures, materials, or characteristics described in conjunction with these embodiments or examples are included in at least one embodiment or example of the disclosure. It should be understood that the schematic representations of these terms within the present disclosure do not necessarily all refer to the same embodiment or example. Moreover, the specific features, structures, materials, or characteristics described herein can be suitably combined in any one or more embodiments or examples. Additionally, those skilled in the art can incorporate different embodiments or examples described herein in a myriad of ways.

The section headings used herein are for organizational purposes only and are not to be construed as limiting the subject matter described.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

What is claimed is:

1. A folding connection mechanism, comprising:
a hinge, wherein the hinge comprises a first connecting member and a second connecting member, wherein the first connecting member and the second connecting member are configured to be rotatably connected to each other;
a lock buckle, wherein the lock buckle is configured to be rotatably positioned on the first connecting member, and wherein the lock buckle is equipped with a lock groove;
a lock pin, wherein the lock pin is positioned on the second connecting member, and wherein the lock pin is configured to be inserted into the lock groove.

2. The folding connection mechanism of claim 1, wherein the first connecting member is provided with a bolt, and the lock buckle is configured to be rotatably sleeved on the bolt.

3. The folding connection mechanism of claim 1, wherein the lock buckle is a flat plate whose width gradually increases from a connecting end with the first connecting member to a free end opposite to the connecting end.

4. The folding connection mechanism of claim 3, wherein the lock groove is arranged on the free end of the lock buckle.

5. The folding connection mechanism of claim 4, wherein the lock groove faces downward when the lock pin is engaged with the lock groove.

6. The folding connection mechanism of claim 4, wherein both ends of the lock buckle are arc-shaped.

7. The folding connection mechanism of claim 1, wherein the lock pin comprises a connecting portion and a limiting portion, wherein the connecting portion is configured to be inserted into the lock groove, and wherein size of the limiting portion is larger than size of the lock groove to limit an axial falling off of the lock buckle.

8. The folding connection mechanism of claim 7, wherein the connecting portion is of a cylindrical shape and the limiting portion is disc-shaped.

9. The folding connection mechanism of claim 1, wherein the first connecting member and the second connecting member are configured to be connected to each other as a tube having a C-shaped cross-section.

10. The folding connection mechanism of claim 1, wherein the first connecting member and the second connecting member are separately provided with a protruding hinge portion comprising a hinge hole, wherein a hinge shaft is configured to pass through the hinge holes of both the first connecting member and the second connecting member, thus enabling the first connecting member and the second connecting member to be rotatably connected.

11. A bed frame comprising a plurality of bed frame units and at least one folding connection mechanism, wherein the at least one folding connection mechanism comprises the folding connection mechanism of claim 1, and wherein the at least one folding connection mechanism is configured to position between at least two respective adjacent bed frame units of the plurality of bed frame units.

12. The bed frame of claim 11, wherein the plurality of bed frame units comprises a plurality of side rods, wherein the first connecting member and the second connecting member are each separately welded to the plurality of side rods.

13. The bed frame of claim 12, wherein the bolt is configured to pass through the side rod.

14. The bed frame of claim 12, wherein the connecting portion of the lock pin extends from one side of the second connecting member through a side rod of the plurality of side rods until the connecting portion connects to the other side of the second connecting member.

15. The bed frame of claim 11, wherein the plurality of bed frame unit is configured to be arranged in at least four sections, wherein the four sections of the plurality of bed frame units are arranged in sequence, and at least two adjacent bed frame units of the plurality of bed frame units are connected by the at least one folding connection mechanism.

16. The bed frame of claim 11, wherein the bed frame comprises four bed frame units and the at least one folding connection mechanism of claim 1, wherein the at least one folding connection mechanism is configured to position between at least two respective adjacent bed frame units of the four bed frame units.

17. The bed frame of claim 16, wherein the plurality of bed frame units comprises a plurality of side rods, wherein the first connecting member and the second connecting member are each separately welded to the plurality of side rods.

18. The bed frame of claim 17, wherein the bolt is configured to pass through the side rod.

19. The bed frame of claim 17, wherein the connecting portion of the lock pin extends from one side of the second connecting member through a side rod of the plurality of side rods until the connecting portion connects to the other side of the second connecting member.

20. The bed frame of claim 11, wherein when the lock groove of the lock buckle is engaged with the connecting portion of the lock pin, the lock groove of the lock buckle is configured to be arranged on one side close to a transverse line of the plurality of bed frame units, while a hinged side of the lock buckle is away from the transverse line of the plurality of bed frame units.
